(19) United States
(12) Patent Application Publication
(10) Pub. No.: US 2022/0138627 A1
(43) Pub. Date: May 5, 2022

(54) COMPUTER-READABLE RECORDING MEDIUM STORING MACHINE LEARNING PROGRAM, MACHINE LEARNING APPARATUS, AND MACHINE LEARNING METHOD

(71) Applicant: FUJITSU LIMITED, Kawasaki-shi (JP)

(72) Inventors: Masaru TODORIKI, Kita (JP); Koji MARUHASHI, Hachioji (JP)

(73) Assignee: FUJITSU LIMITED, Kawasaki-shi (JP)

(21) Appl. No.: 17/464,738

(22) Filed: Sep. 2, 2021

(30) Foreign Application Priority Data
Oct. 29, 2020 (JP) 2020-181443

(51) Int. Cl. G06N 20/00; G06K 9/62

(52) U.S. Cl. CPC G06N 20/00; G06K 9/6256; G06K 9/6255

(57) ABSTRACT

A machine learning method is performed by a computer. The method includes acquiring first graph information, generating second graph information, without changing a coupling state between nodes included in the first graph information, by a change process of changing an attribute value of a coupling between the nodes, and performing machine learning on a model, based on the first graph information and the second graph information.

### CROSS-REFERENCE TO RELATED APPLICATION

This application is based upon and claims the benefit of priority of the prior Japanese Patent Application No. 2020-181443, filed on Oct. 29, 2020, the entire contents of which are incorporated herein by reference.

### FIELD

The embodiments discussed herein are related to a computer-readable medium storing a machine learning program, a machine learning apparatus, and a machine learning method.

### BACKGROUND

In the related art, information is analyzed by using a model that has experienced machine learning with graph information including a plurality of nodes and edges coupling the nodes. When the machine learning is performed on the model, new graph information is generated based on a small amount of graph information available as training data, thereby extending the training data.

For example, a training data generation apparatus configured to generate training data for object discrimination analysis by Mahalanobis distance has been proposed. This apparatus performs region division in accordance with an extracted object region and densities of pixels constituting the extracted object region, generates a plurality of small regions, and generates a graph representing an adjacency relationship between the plurality of small regions. The apparatus uses, as a feature amount, an attribute value of an edge of the graph, which is a weighted sum of absolute values of differences of densities, heights, and widths between adjacent small regions among the plurality of small regions, so as to generate feature amount data including all the feature amounts. The apparatus summarizes the generated feature amount data for each of object types of the object regions. As for the above-discussed feature amount data, the apparatus adds some dummy feature amounts to the feature amount data having a smaller number of feature amounts than the greatest number of feature amounts in order to allow the feature amount data having the smaller number of feature amounts to have the same number of feature amounts as the feature amount data having the greatest number of feature amounts, thereby forming the training data. Japanese Laid-open Patent Publication No. 2007-334755 is disclosed as related art.

A state determination apparatus configured to construct a causal graph that is extended with respect to the causal graph of related art in a machine learning phase has been proposed. This apparatus sets, as a first causal graph, a graph representing a relationship between a first layer corresponding to a state of each of constituent elements of a system and a second layer corresponding to a state of observation information being output from each constituent element of the first layer in the system. The apparatus constructs a second causal graph, with respect to the first causal graph, in which a third layer corresponding to a state of second observation information obtained by converting the observation information being output from each constituent element of the first layer is added between the first layer and the second layer. Japanese Laid-open Patent Publication No. 2018-124829 is disclosed as related art.

### SUMMARY

According to an aspect of the embodiments, a machine learning method includes acquiring first graph information, generating second graph information, without changing a coupling state between nodes included in the first graph information, by a change process of changing an attribute value of a coupling between the nodes, and performing machine learning on a model, based on the first graph information and the second graph information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a machine learning apparatus;

FIG. 2 is a diagram illustrating an example of a graph set corresponding to a first graph information set;

FIG. 3 is a diagram illustrating an example of first graph information;

FIG. 4 is a diagram illustrating another example of the first graph information;

FIG. 5 is a diagram for explaining a local index and a global index;

FIG. 6 is a diagram for explaining generation of second graph information by a method of randomly changing weights;

FIG. 7 is a diagram schematically illustrating an example of generation of the second graph information by a method of randomly changing weights;

FIG. 8 is a diagram for explaining a relative ratio of an appearance frequency in a histogram;

FIG. 9 is a diagram for explaining generation of the second graph information by a method of changing weights in accordance with a histogram;

FIG. 10 is a diagram schematically illustrating an example of generation of the second graph information by a method of changing weights in accordance with a histogram;

FIG. 11 is a block diagram schematically illustrating a configuration of a computer that functions as a machine learning apparatus;

FIG. 12 is a flowchart illustrating an example of machine learning processing;

FIG. 13 is a diagram illustrating a comparison between evaluation of a method of randomly changing weights and evaluation of a comparative example;

FIG. 14 is a diagram illustrating an example of evaluation comparisons by magnitude of dispersion of probability distribution that is applied at the time of randomly changing weights;

FIG. 15 is a diagram illustrating an example of evaluation in a case where the number of pieces of data is increased 10 times by data extension;

FIG. 16 is a diagram illustrating an example of evaluation on each of a plurality of pieces of compound data of different types; and

FIG. 17 is a diagram illustrating a comparison between evaluation of a method of changing weights in accordance with a histogram and evaluation of a comparative example.

### DESCRIPTION OF EMBODIMENTS

When new graph information is generated by, for example, adding an edge to the original graph information and data extension of training data is carried out, there is a problem in that the purity of the training data decreases, and as a result, accuracy of machine learning is lowered in some cases.

As one aspect, an object of the disclosed technology is to suppress deterioration in learning accuracy in a case where machine learning is performed on a model by carrying out data extension of graph information.

Hereinafter, an example of an embodiment according to the disclosed technology will be described with reference to the drawings.

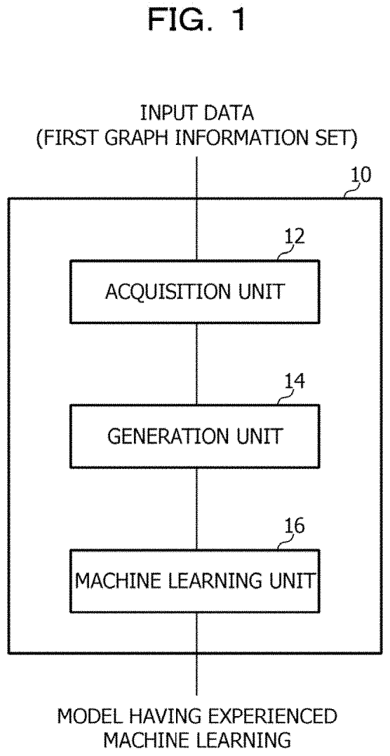

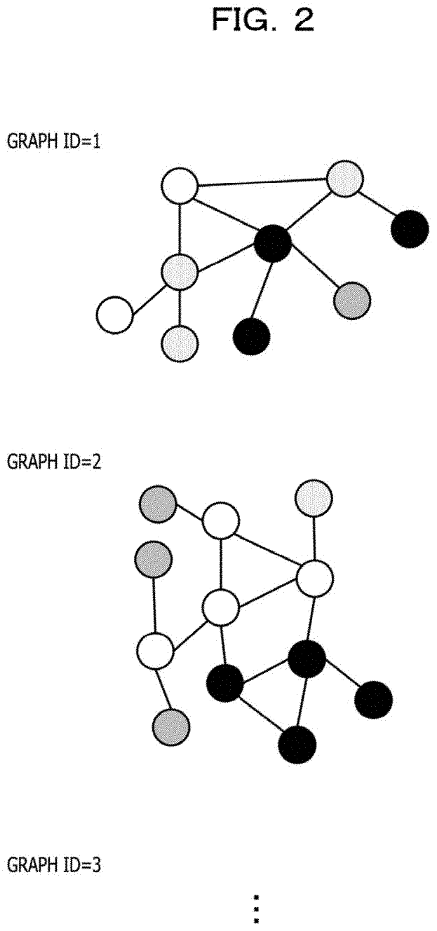

As illustrated in FIG. 1, a graph information set, which is training data for performing machine learning on a model, is input as input data to a machine learning apparatus 10 according to the present embodiment. Hereinafter, graph information as input data is also referred to as “first graph information”. FIG. 2 illustrates an example of a graph set corresponding to a first graph information set. As illustrated in FIG. 2, the graph set includes a plurality of graphs, and each graph is assigned a graph ID, which is identification information of the graph. Each graph includes a plurality of nodes (circles in FIG. 2) and edges (straight lines in FIG. 2) coupling the nodes. In FIG. 2, in accordance with a category of each node classified by information held by the node, a shading mode in the circle indicating each node is made different.

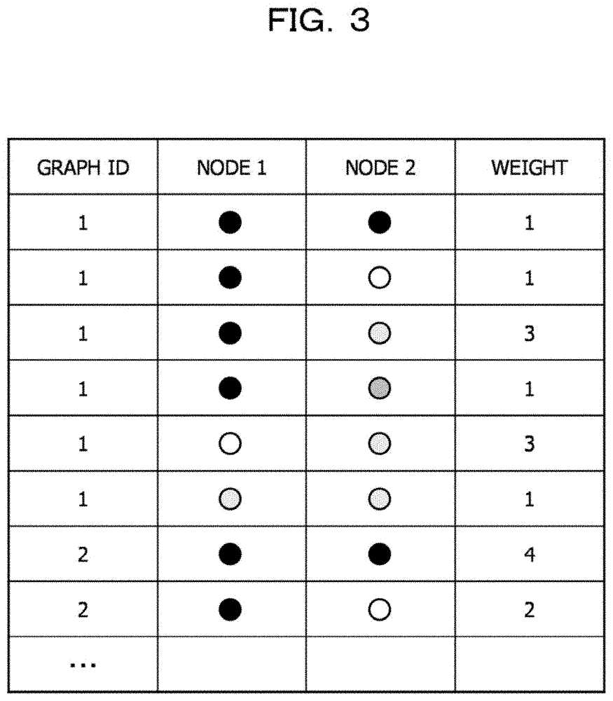

In the present embodiment, as illustrated in FIG. 3, for example, the graph information set is a collection of a plurality of pieces of graph information, in which the graph ID and the graph information of each graph are associated. In the example of FIG. 3, the graph information is information in which relationships between nodes included in the graphs are represented in a table format. For example, a node coupled to one end of an edge is referred to as a “node 1”, a node coupled to the other end of the edge is referred to as a “node 2”, and a “weight” indicating a relationship between the nodes 1 and 2 is associated with each edge. The weight is an example of an “attribute value of coupling between nodes” in the disclosed technology. In the example of FIG. 3, for each type of edge, the number of appearances of the type of edge in the graph is associated as a weight to form the graph information. The type of edge refers to each combination of categories of the nodes at both ends of the edge.

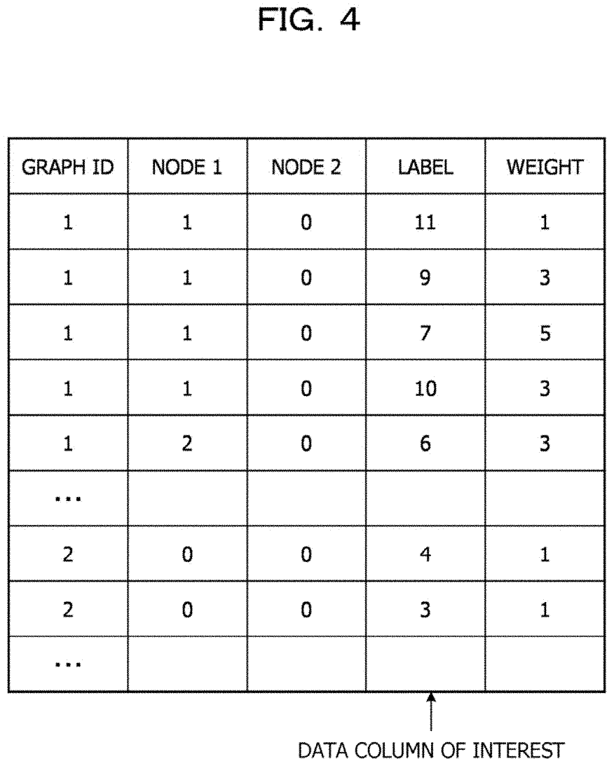

FIG. 4 illustrates another example of the graph information set. In the example of FIG. 4, the information is not information for each edge type as in the graph information illustrated in FIG. 3, but is graph information in which a weight is associated with each edge included in the graph. In this case, the weight may be an index representing strength of the coupling between the node 1 and the node 2. In the example of FIG. 4, in addition to the data columns held by the graph information illustrated in FIG. 3, a data column of “label”, which is attribute information of the nodes or edges, is included. In FIG. 4, only one “label” column is illustrated, but a plurality of label columns, such as a label representing attribute 1 of the node 1, a label representing attribute 2 of the node 1, a label representing attribute 1 of the node 2, and the like may be included. The label is an example of a “specific value associated with a node” in the disclosed technology.

In the example of FIG. 3, nodes are represented by circles in the graph information, but numerical values indexing the nodes are used in actual processing. Indexing such as discretization of values may be performed on other data columns. In the graph information illustrated in FIG. 4, the value of the “label” is indexed. For example, when the node 1 is a company name and the label is a type of business of the node 1, the label is indexed by representing each type of business by a numerical value. Types of indices include a local index and a global index. The local index is an index that places emphasis on similarity of the graph structure, for example, places emphasis on closeness of the topology, and is individually set for each graph ID. The global index is an index that places emphasis on a specific coupling between nodes, and is commonly set for all pieces of graph information.

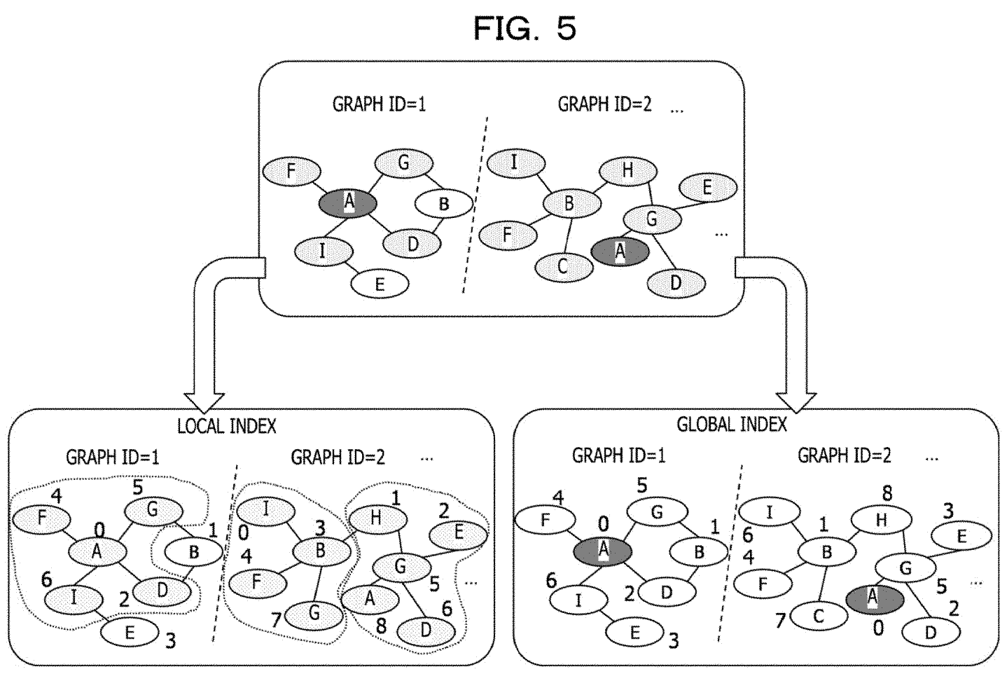

For example, as illustrated in FIG. 5, in a graph in which each person (A, B, C, and the like) is represented by a node (an ellipse in FIG. 5) and the nodes are coupled by edges based on relations between the persons, a local index is used in a case where attention is not paid to a node of a specific category (specific person), but paid to a fact that there is some common behavior or relationship between the graphs, or the like. On the other hand, for example, in a case where attention is paid to a node of a specific category (specific person) and it is desired to know the behavior of the specific person across all the graphs, the global index is used.

The machine learning apparatus 10 functionally includes, as illustrated in FIG. 1, an acquisition unit 12, a generation unit 14, and a machine learning unit 16.

The acquisition unit 12 acquires the first graph information set having been input to the machine learning apparatus 10 as input data. The acquisition unit 12 receives a designation telling whether to carry out data extension from a user. When the acquisition unit 12 has received the designation from the user to carry out data extension, the acquisition unit 12 transfers the acquired first graph information set to the generation unit 14. On the other hand, when the acquisition unit 12 has received the designation from the user to not carry out data extension, the acquisition unit 12 transfers the acquired first graph information set to the machine learning unit 16.

The generation unit 14 receives the first graph information set from the acquisition unit 12. For each piece of the first graph information included in the first graph information set, the generation unit 14 generates second graph information, without changing coupling states between the nodes included in the first graph information, by a change process of changing attribute values of couplings between the nodes. For example, the generation unit 14 generates the second graph information by changing the weights associated with the edges, without adding any new edge between the nodes included in the first graph information and without deleting any existing edge included in the first graph information. To rephrase, the generation unit 14 generates the second graph information in which the weights that are features of the graph information are changed while maintaining the configuration of the first graph information, for example, the skeleton of the first graph information.

For example, the generation unit 14 receives a designation from a user of an extension method for data extension. In the present embodiment, as the extension method, a method of randomly changing weights and a method of changing weights based on frequency distribution of a data column of interest (hereinafter, also referred to as a “histogram-based method”) may be selectable.

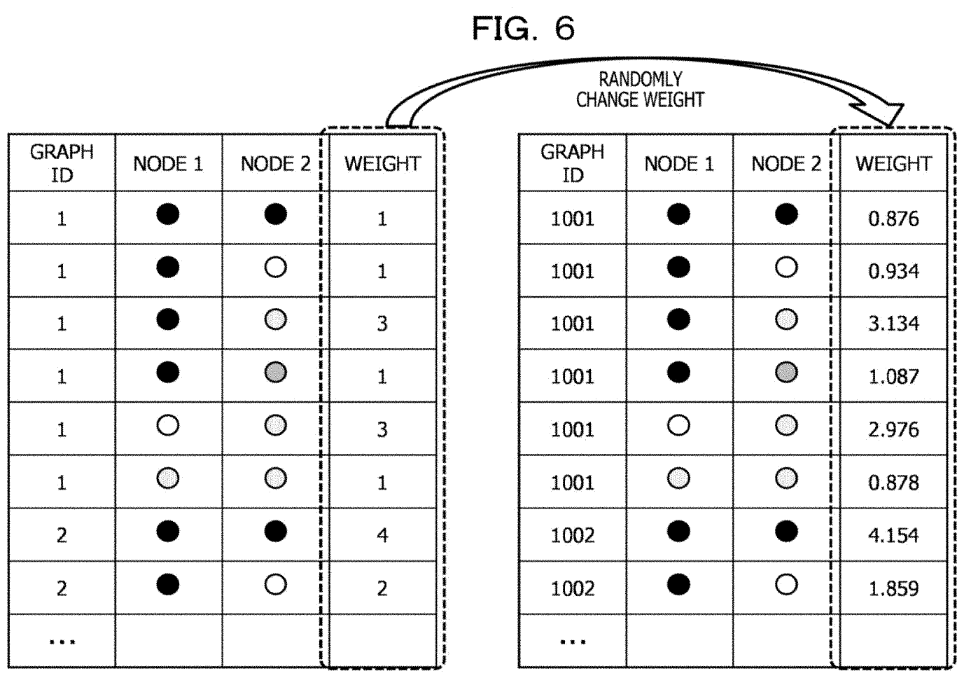

When the method of randomly changing weights is designated by the user, the generation unit 14 randomly changes the weights of the first graph information as a change process of the weights. For example, as illustrated in FIG. 6, the generation unit 14 generates the second graph information by randomly multiplying each weight of the first graph information by a value of a predetermined probability distribution. For example, when a normal distribution with an average of 1 is employed as the predetermined probability distribution, the generation unit 14 generates, as the second graph information, new graph information in which weights of relationships between the nodes are dispersed in accordance with the normal distribution with the average of 1. By using the normal distribution for the change process of the weights, natural data extension may be achieved. The predetermined probability distribution is not limited to a case of normal distribution, and any probability distribution having a known distribution form may be applicable. The index of the graph information in the case where the method of the random change is applied may be any of a local index and a global index.

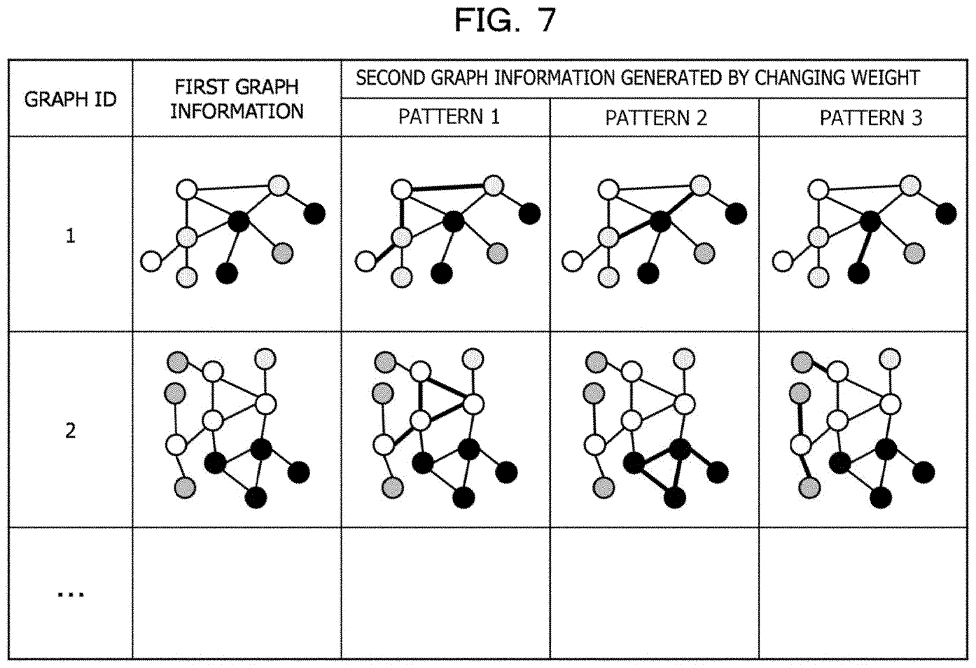

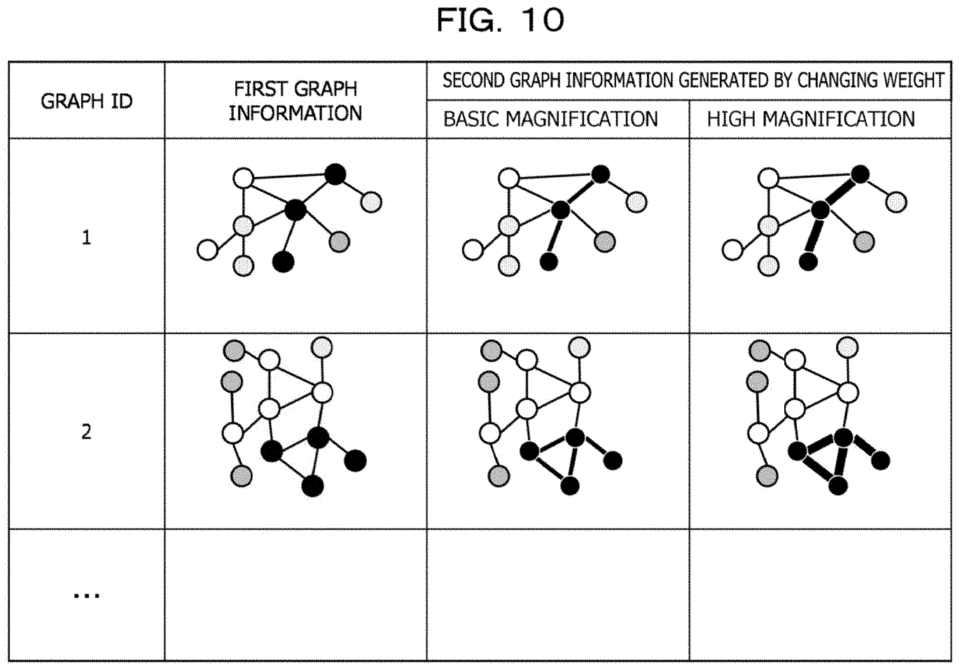

The generation unit 14 may generate a plurality of pieces of the second graph information from one piece of the first graph information by applying a plurality of different patterns as patterns for randomly multiplying the weights of the first graph information by the values of the predetermined probability distribution. FIG. 7 illustrates an example in which three patterns of the second graph information are generated from one first graph information. In FIG. 7, the thickness of an edge represents strength of the relationship between nodes, for example, the magnitude of the weight. The same applies to FIG. 10 to be described later.

When the user designates the histogram-based method, the generation unit 14 multiplies the weight associated with the edge by a coefficient corresponding to the appearance frequency of the value of the label or node corresponding to the edge in the first graph information, as a change process of the weights. By doing so, the generation unit 14 changes the weights of the first graph information.

For example, the generation unit 14 receives the designation of a data column of interest in the first graph information from the user. As the data column of interest, for example, a data column including numerical values or category values that are important for a given task and commonly appear throughout the graph information is designated. For example, a data column representing labels is likely to be designated as the data column of interest. Due to the nature of the process, the global index is targeted as the index of the graph information when the histogram-based method is applied.

For example, in the example of the graph information in FIG. 4, a case is considered in which the graph information represents financial transaction data, and a model for detecting reliable transaction partners is generated by machine learning. For example, in the graph information, it is assumed that the node 1 is a remittance source enterprise, the node 2 is a remittance destination enterprise, and for the labels, there are included a type of business, a scale and an organizational structure of the remittance source or remittance destination enterprise, a transaction period between the remittance source enterprise and the remittance destination enterprise, and the like. The weight is assumed to be a transaction value between the remittance source enterprise and the remittance destination enterprise. In this case, a data column indicating characteristic enterprise information of the transaction partners is selected as the data column of interest. For example, when it is considered that characteristic elements of the transaction relationship between the enterprises indicated by the node 1 and the node 2 are related to a type of business of the remittance source enterprise, a label column indicating the type of business of the remittance source enterprise is designated as the data column of interest.

The data column to be designated as the data column of interest is not limited to the label column. For example, a case is considered in which the graph information represents Internet log data and a model for detecting unauthorized access is generated by machine learning. For example, in the graph information, it is assumed that the node 1 is a transmission source IP address, the node 2 is a transmission destination IP address, and the weight is a packet amount in one communication. When unauthorized communication is transmitted from a specific IP address, and the transmission source IP address from which communication is frequently performed noticeably is considered to be a stepping-stone for unauthorized access, the node 1 is selected as the data column of interest. Accordingly, a histogram-based method may be applied even to graph information that does not include a label.

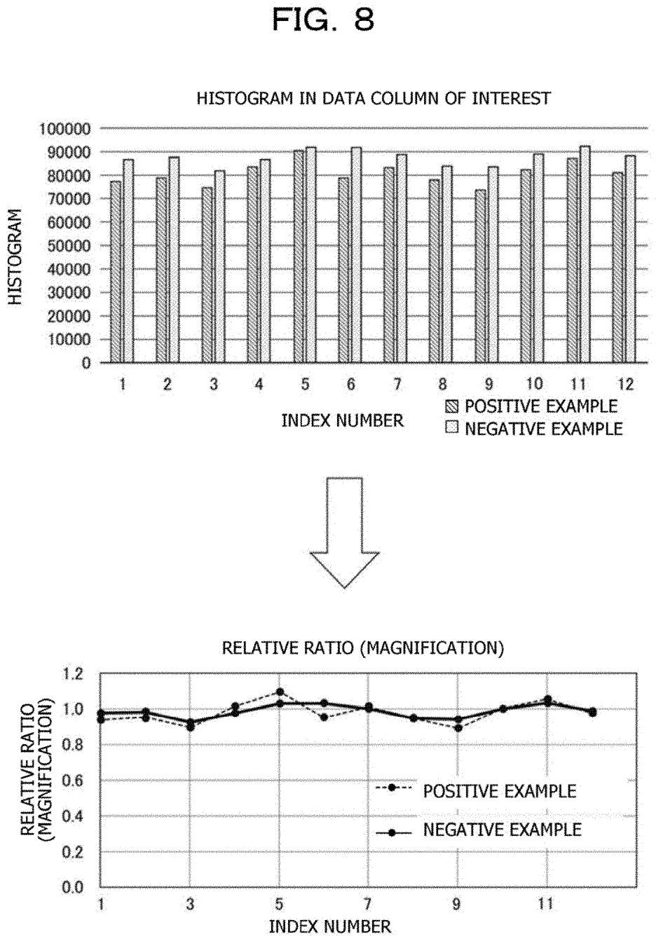

As illustrated in the upper stage of FIG. 8, the generation unit 14 calculates a histogram indicating the appearance frequency of the edge (each row of the graph information) for each value (index number) of the designated data column of interest in the first graph information set. It is assumed that information indicating whether to become a positive example or a negative example with respect to a given task is assigned to each piece of the graph information, and FIG. 8 illustrates an example in which the histogram is calculated for each of the positive example and the negative example.

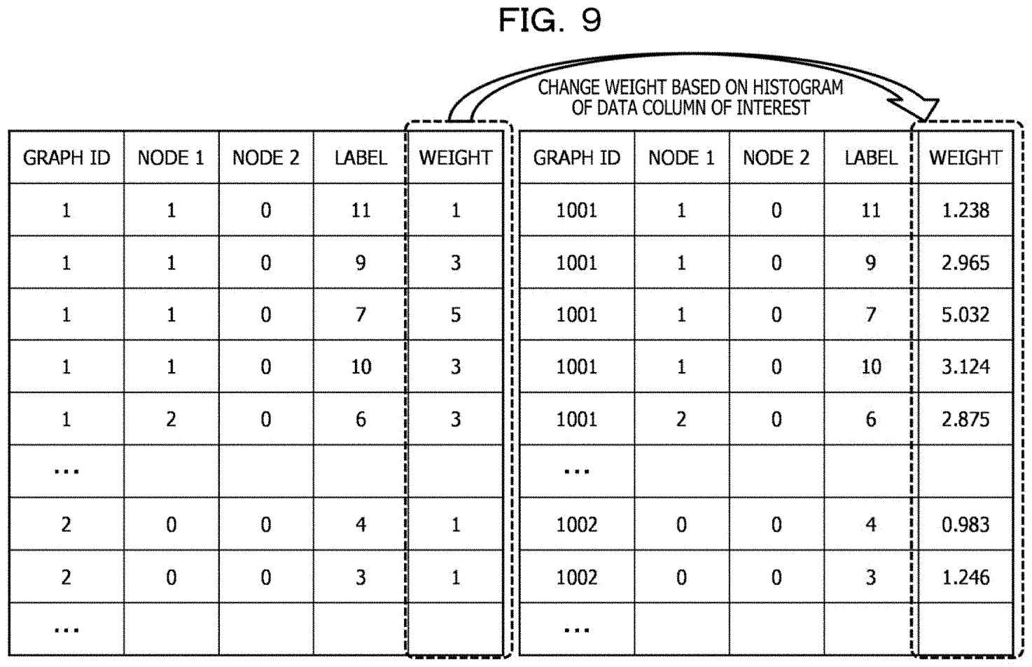

As illustrated in the lower stage of FIG. 8, the generation unit 14 determines a relative ratio of the appearance frequency corresponding to each index number with respect to a predetermined reference value based on the calculated histogram. As illustrated in FIG. 9, the generation unit 14 multiplies the weight of the edge corresponding to each index number of the data column of interest by the determined relative ratio so as to generate the second graph information in which the weights of the first graph information are changed. The generation unit 14 may take the predetermined reference value as an average value or a median of the appearance frequencies corresponding to the index numbers in the histogram. In this case, it is possible to suppress occurrence of bias in changing the weights. The generation unit 14 may adjust the relative ratio obtained for each index number to a value within a predetermined range centered at 1. In this case, it is possible to suppress occurrence of a significant influence on the change of the weights.

The generation unit 14 may generate a plurality of pieces of the second graph information from one piece of the first graph information in the following manner: in addition to the second graph information generated by multiplying the weight by the determined relative ratio as is, another piece of second graph information is generated by multiplying the weight by a value obtained by multiplying the relative ratio by a predetermined factor. FIG. 10 illustrates an example in which two patterns of the second graph information are generated from one first graph information. In the example of FIG. 10, a case in which the weight is multiplied by the determined relative ratio as is, is referred to as “basic magnification”, and a case in which the weight is multiplied by a value obtained by multiplying the relative ratio by a predetermined factor larger than one (for example, two times), is referred to as “high magnification”.

The generation unit 14 generates pieces of the second graph information for pieces of the first graph information included in the first graph information set, thereby forming the second graph information set. The generation unit 14 assigns a graph ID different from that of the first graph information to each piece of the generated second graph information. For example, in a case where graph IDs of 0, 1, . . . , N are used in the first graph information set, the generation unit 14 assigns graph IDs of N+1, N+2, and the like to pieces of the second graph information. The generation unit 14 transfers the first graph information set and the generated second graph information set to the machine learning unit 16.

The machine learning unit 16 performs machine learning on the model based on the first graph information set transferred from the acquisition unit 12, or based on the first graph information set and the second graph information set transferred from the generation unit 14. For example, in the case where data extension is not carried out, the machine learning unit 16 trains the model only with the first graph information set. In the case where data extension is carried out, the machine learning unit 16 trains the model by using the first graph information set and the data-extended second graph information set. Examples of a machine learning algorithm using graph information includes Deep Tensor, Graph Convolutional Networks (GCN), and the like. The machine learning unit 16 outputs the trained model.

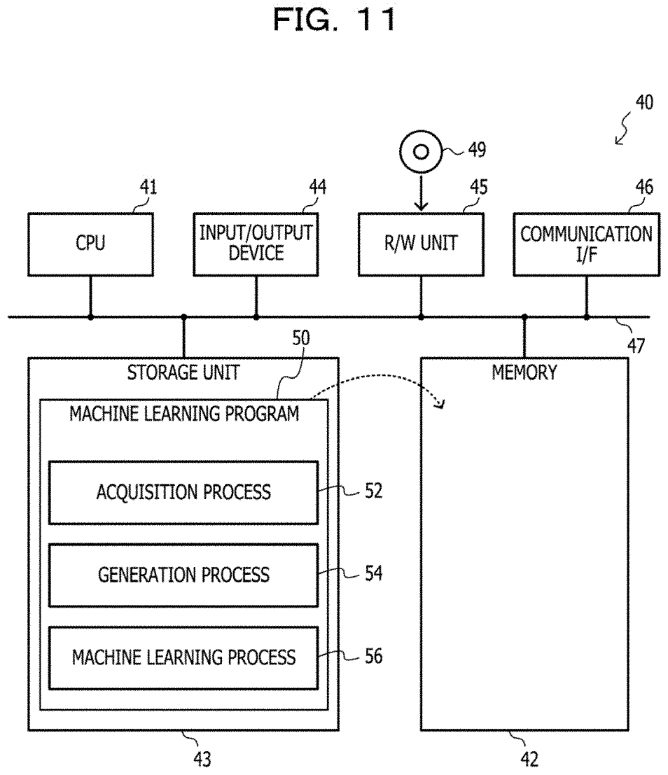

The machine learning apparatus 10 may be implemented by, for example, a computer 40 illustrated in FIG. 11. The computer 40 includes a central processing unit (CPU) 41, a memory 42 serving as a temporary storage area, and a storage unit 43, which is nonvolatile. The computer 40 also includes an input/output device 44 such as an input unit, a display unit, and the like, and a read/write (R/W) unit 45, which controls reading and writing of data from and to a storage medium 49. The computer 40 also includes a communication interface (I/F) 46, which is coupled to a network such as the Internet. The CPU 41, the memory 42, the storage unit 43, the input/output device 44, the R/W unit 45, and the communication I/F 46 are coupled to each other via a bus 47.

The storage unit 43 may be achieved by a hard disk drive (HDD), a solid-state drive (SSD), a flash memory, or the like. The storage unit 43 serving as a storage medium stores a machine learning program 50 for causing the computer 40 to function as the machine learning apparatus 10. The machine learning program 50 includes an acquisition process 52, a generation process 54, and a machine learning process 56.

The CPU 41 reads out the machine learning program 50 from the storage unit 43, loads the read machine learning program 50 on the memory 42, and sequentially executes the processes included in the machine learning program 50. The CPU 41 operates as the acquisition unit 12 illustrated in FIG. 1 by executing the acquisition process 52. The CPU 41 also operates as the generation unit 14 illustrated in FIG. 1 by executing the generation process 54. The CPU 41 also operates as the machine learning unit 16 illustrated in FIG. 1 by executing the machine learning process 56. Thus, the computer 40 configured to execute the machine learning program 50 functions as the machine learning apparatus 10. The CPU 41 configured to execute the program is hardware.

The functions enabled by the machine learning program 50 may also be enabled by, for example, a semiconductor integrated circuit, more specifically, an application-specific integrated circuit (ASIC) or the like.

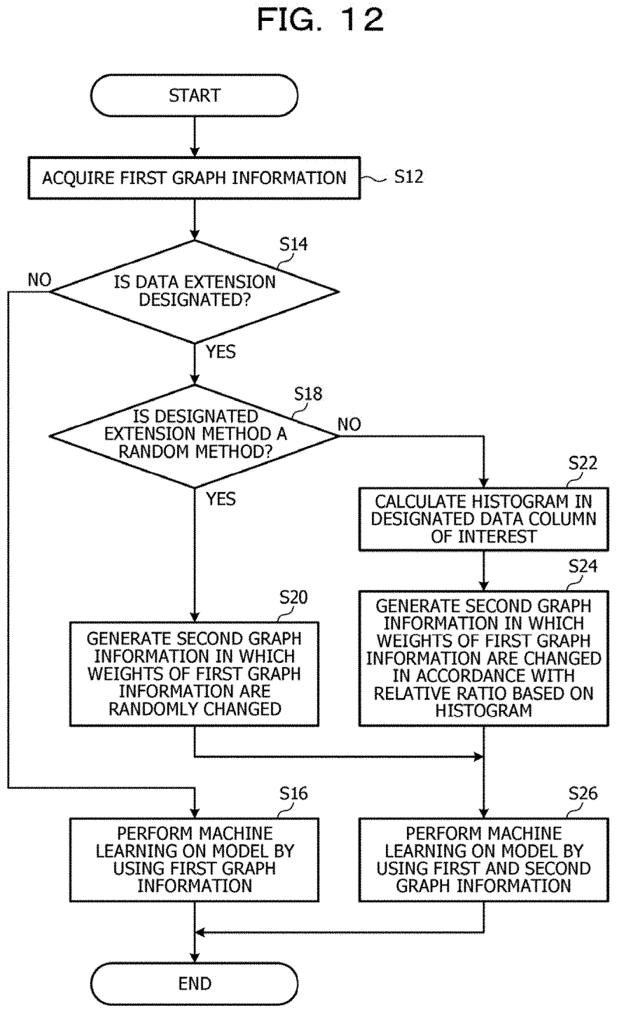

Next, operations of the machine learning apparatus 10 according to the present embodiment will be described. When the first graph information set is input to the machine learning apparatus 10 as input data, machine learning processing illustrated in FIG. 12 is executed in the machine learning apparatus 10. The machine learning processing is an example of the machine learning method of the disclosed technology.

In step S12, the acquisition unit 12 acquires the first graph information set having been input to the machine learning apparatus 10 as input data.

Subsequently, in step S14, the acquisition unit 12 receives, from a user, a designation telling whether to carry out data extension, and determines whether the designation telling that the data extension has to be carried out is received. When the designation telling that the data extension has to be carried out is received, the acquisition unit 12 transfers the first graph information set to the generation unit 14, and the processing goes to step S18. On the other hand, when the designation telling that the data extension does not have to be carried out is received, the acquisition unit 12 transfers the first graph information set to the machine learning unit 16, and the processing goes to step S16.

In step S16, the machine learning unit 16 performs machine learning on the model based on the first graph information set transferred from the acquisition unit 12, outputs the trained model, and then the machine learning processing is ended.

In step S18, the generation unit 14 receives, from the user, a designation of an extension method for data extension, and determines whether the received extension method is a method to randomly change weights or a method to use a histogram. In the case of the method to randomly change weights, the processing goes to step S20, while in the case of the method to use a histogram, the processing goes to step S22.

In step S20, the generation unit 14 generates the second graph information by randomly multiplying the weights of the first graph information by the values of a predetermined probability distribution. The generation unit 14 transfers the first graph information set and the generated second graph information set to the machine learning unit 16, and then the processing goes to step S26.

Meanwhile, in step S22, the generation unit 14 receives a designation from the user of a data column of interest in the first graph information. The generation unit 14 calculates a histogram indicating the appearance frequency of the edge (each row of the graph information) for each value (index number) of the designated data column of interest in the first graph information set.

Subsequently, in step S24, the generation unit 14 determines a relative ratio of the appearance frequency corresponding to each index number with respect to a predetermined reference value based on the calculated histogram. The generation unit 14 multiplies the weight of the edge corresponding to each index number of the data column of interest by the determined relative ratio so as to generate the second graph information in which the weights of the first graph information are changed. The generation unit 14 transfers the first graph information set and the generated second graph information set to the machine learning unit 16, and then the processing goes to step S26.

In step S26, the machine learning unit 16 perforins machine learning on the model based on the first graph information set and the second graph information set transferred from the generation unit 14 and outputs the trained model, and then the machine learning processing is ended.

As described above, the machine learning apparatus according to the present embodiment acquires the first graph information and generates the second graph information by the change process in which, without changing the coupling states between the nodes included in the first graph information, the attribute values of couplings between the nodes are changed. The machine learning apparatus trains the model based on the first graph information and the second graph information. With this, by changing only the weight representing the relationship between the nodes of the graph information without changing the basic structure of the graph information, it is possible to increase variations of the training data holding the skeleton of the first graph information and carry out data extension. As a result, it is possible to suppress deterioration in learning accuracy in the case of training the model by carrying out data extension of the graph information.

Since a technique good at feature extraction from the overall graph rather than from a local area, such as Deep Tensor, is particularly suited to randomness that exhibits an effect of making fine features less noticeable, the effect of applying the technique of randomly changing weights is high in the present embodiment.

Accuracy of a model evaluated by using test data will be described below, where the evaluated model was a model having experienced machine learning with the algorithm of Deep Tensor by using a certain input data set. In this case, Accuracy (ACC) and Area Under the Curve (AUC) were used as evaluation indicators. ACC is a ratio of the number of cases where predictions by the model match correct answers with respect to all test results. AUC is an indicator for performance evaluation of a classifier, and corresponds to an area on the lower side of a Receiver Operating Characteristic (ROC) curve. The ROC curve is a curve established by a true positive rate (TPR) and a false positive rate (FPR) described below, and is used to measure the discrimination performance of the classifier. As AUC approaches 1, the discrimination performance is higher, and the prediction is a random prediction when AUC equals 0.5.

TPR=TP/(TP+FN)

FPR=FP/(FP+TN)

TP: prediction is positive, and correct answer is positive

FN: prediction is negative, and correct answer is positive

FP: prediction is positive, and correct answer is negative

TN: prediction is negative, and correct answer is negative

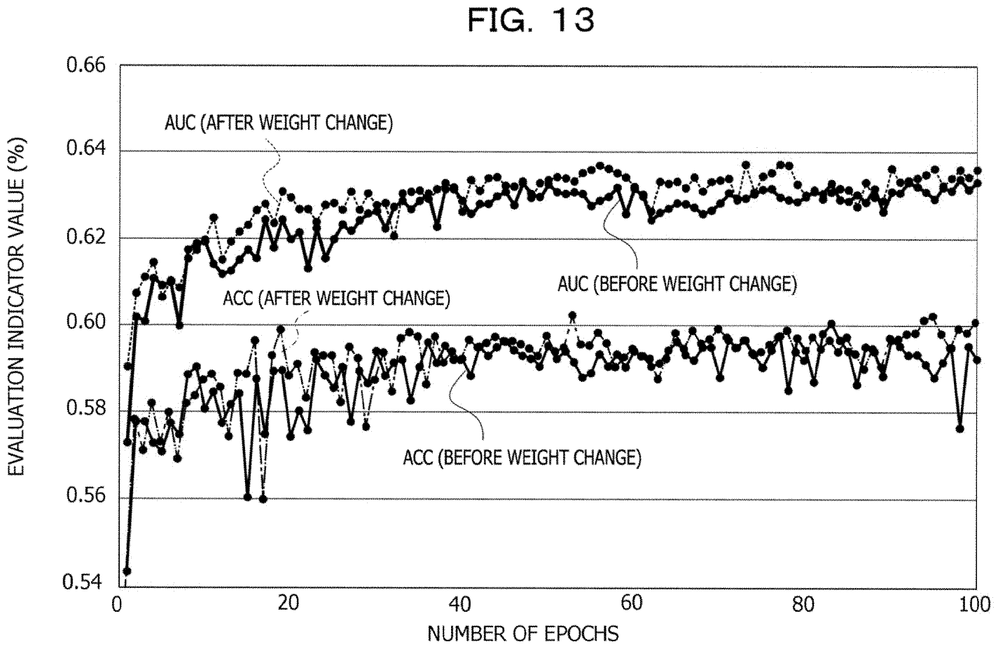

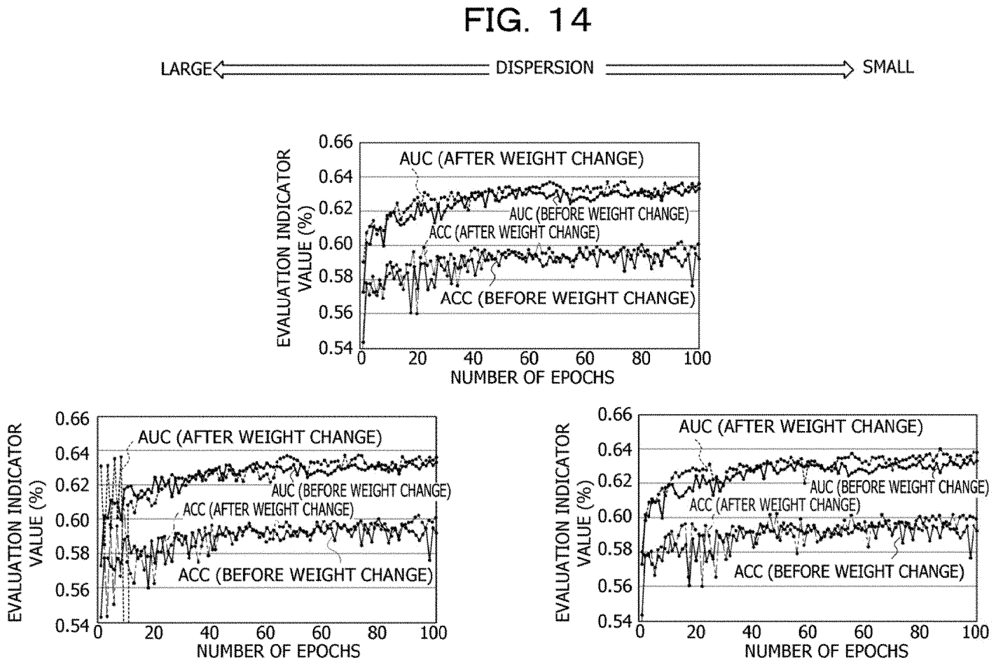

FIG. 13 illustrates an example of comparison of ACC and AUC for each of learning epochs before and after the random change of the weights. In the example of FIG. 13, as an example of the present embodiment (hereinafter, referred to as “present technique”), a case was employed in which the weights were randomly changed based on a normal distribution with an average of 1, and one piece of the second graph information was generated from one piece of the first graph information. In the present technique, for example, the targeted model was a model subjected to machine learning in which the amount of data was extended twice from the original amount of data through using the first graph information and the second graph information. As an example before the weight change (hereinafter, referred to as a “comparative example”), the targeted model was a model having been subjected to machine learning with the data obtained by simply doubling the first graph information. In FIG. 13, AUC (after weight change) and ACC (after weight change) are evaluation indicators for the present technique, and AUC (before weight change) and ACC (before weight change) are evaluation indicators for the comparative example. The same applies to FIGS. 14, 15, and 17 described below. As illustrated in FIG. 13, in both ACC and AUC, the present technique exhibits a higher value than the comparative example as a whole, from which it is understood that the present technique suppresses deterioration in the accuracy of machine learning.

FIG. 14 illustrates an example of comparisons of evaluation by magnitude of dispersion of probability distribution that is applied at the time of randomly changing the weights. The present technique and the comparative example are the same as those in the case of FIG. 13. When the dispersion is large (lower left in FIG. 14), ACC and AUC of the present technique vary rapidly and are not stable in an early stage where the number of epochs is smaller. In addition, it is difficult to say that the accuracy is improved as a whole in comparison with the comparative example. When the dispersion is small (lower right in FIG. 14), AUC of the present technique is more accurate than that of the other dispersion conditions in the early stage where the number of epochs is smaller, and the highest result is consequently obtained in the range of the present dispersion conditions. The upper stage of FIG. 14 indicates a case where the dispersion takes an intermediate value, which is the same as the case of FIG. 13. This suggests that there exists an appropriate dispersion condition under which higher accuracy is obtained than in the case illustrated in FIG. 13, and, for example, it is expected that the smaller the dispersion, the higher the possibility is.

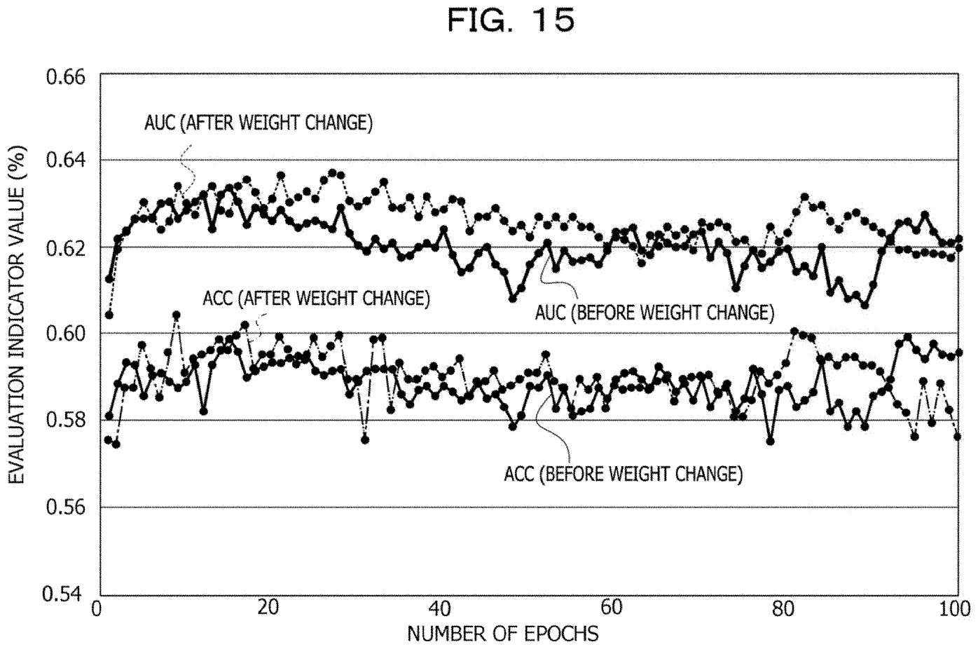

Next, FIG. 15 illustrates an example of evaluation in a case where the number of pieces of data is increased 10 times by data extension. In the present technique, nine pieces of the second graph information were generated from one piece of the first graph information, whereby the data was extended 10 times the original number of pieces of data. In the comparative example, the first graph information was simply multiplied by 10. The other conditions are the same as those in the example of FIG. 13. As illustrated in FIG. 15, since over-learning is more likely to occur than in the case where the number of pieces of data is extended twice, the learning accuracy tends to decrease as the number of epochs increases in both of the present technique and the comparative example. However, ACC and AUC of the present technique are higher; for example, when the number of epochs is around 20, the accuracy has already reached a level of accuracy with the number of epochs being 100 of the case where the number of pieces of data is expanded twice, from which it is understood that the learning is performed at high speed.

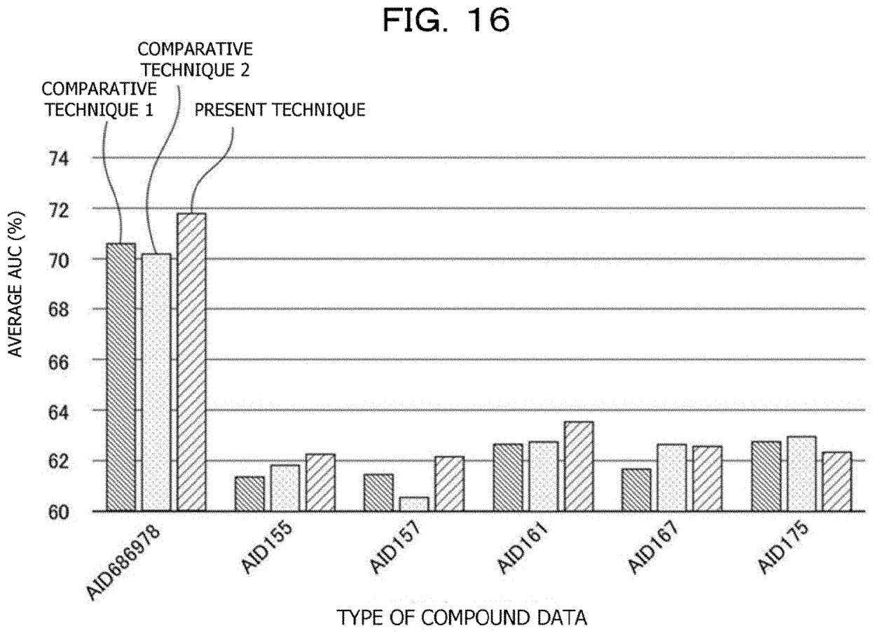

In the above description, Deep Tensor is cited as an example of the machine learning algorithm. However, even with a technique such as GCN that is relatively good at local feature extraction, there is a case in which a technique of randomly changing weights may be effective depending on the characteristics of graph information. FIG. 16 illustrates an example of evaluation for each of pieces of graph information (hereinafter, referred to as “compound data”) regarding a plurality of different types of compounds as identified by AID686978, AID155, etc. In the example of FIG. 16, the average of AUCs obtained in 10 tests (hereinafter, referred to as the “average AUC”) is used as an evaluation indicator. This present technique is of a case, similar to that of FIG. 15, in which the number of pieces of data is extended 10 times. Comparative technique 1 is of a case in which only the first graph information is used without data extension, while comparative technique 2 is of a case in which the first graph information is simply multiplied by 10. As illustrated in FIG. 16, the accuracy of the present technique is higher than that of comparative techniques 1 and 2 in some cases, and the effect of the method of randomly changing weights is expected to be obtained regardless of the machine learning algorithm.

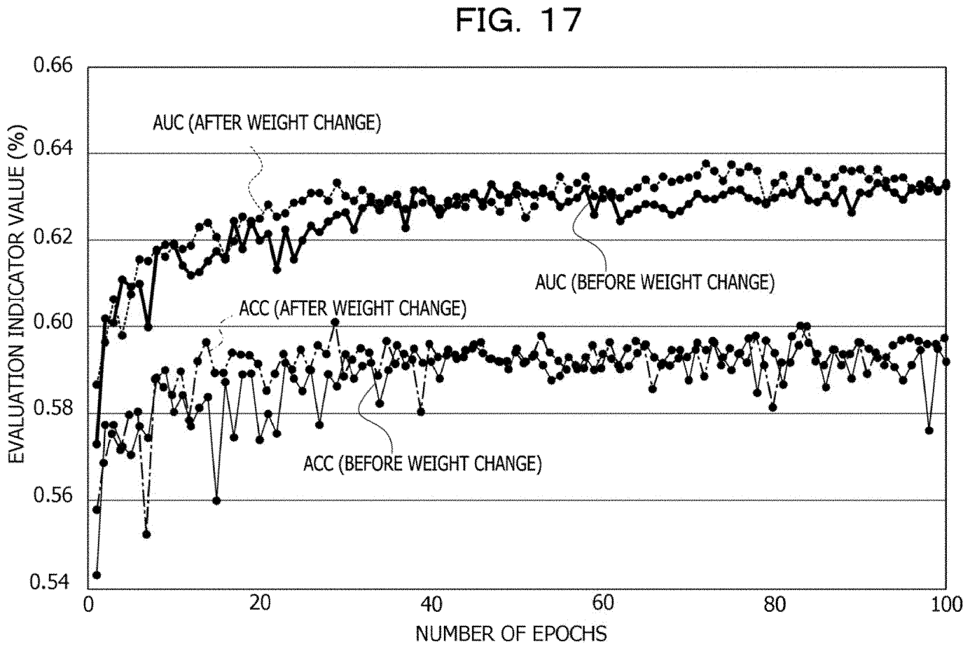

In the histogram-based method, since the weights may be changed so that the features related to the data column of interest are emphasized, it is possible to improve learning accuracy in accordance with a task. FIG. 10 illustrates an example where couplings between the nodes indicated by black circles are considered to be important and the second graph information in which edges between the black circle nodes are emphasized is generated. FIG. 17 illustrates an evaluation example of the comparative example and the present technique in which weights are changed by the histogram-based method. Conditions other than the method of changing the weights in the present technique are the same as those in the example in FIG. 13. It is understood that ACC and AUC of the present technique are more stable and accurate than those of the comparative example as a whole. Even when an appropriate distribution state of the probability distribution to be applied in the method of randomly changing the weights is unknown, data extension may be accurately carried out by applying the histogram-based method.

In the above-described embodiment, an example of graph information that defines a coupling between two nodes has been described, but the disclosed technology is also applicable to graph information of a hyper graph that defines weights for couplings among a plurality of nodes including three or more nodes.

In the above embodiment, an aspect is described in which the machine learning program is stored (installed) in advance in the storage unit, but the embodiment is not limited thereto. The program according to the disclosed technology is able to be provided in a form stored in a storage medium such as a compact disc read-only memory (CD-ROM), a Digital Versatile Disc (DVD)-ROM, a Universal Serial Bus (USB) memory, or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process, the process comprising:
acquiring first graph information;
generating second graph information, without changing a coupling state between nodes included in the first graph information, by a change process of changing an attribute value of a coupling between the nodes; and
performing machine learning on a model, based on the first graph information and the second graph information.

2. The non-transitory computer-readable recording medium according to claim 1,
wherein the without changing the coupling state comprises not adding any new coupling between the nodes included in the first graph information and not deleting any existing coupling between the nodes included in the first graph information.

3. The non-transitory computer-readable recording medium according to claim 1,
wherein the change process includes randomly changing the attribute value.

4. The non-transitory computer-readable recording medium according to claim 3,
wherein the randomly changing the attribute value includes randomly multiplying the attribute value by a value of a specific probability distribution.

5. The non-transitory computer-readable recording medium according to claim 1,
wherein the change process includes multiplying a coefficient corresponding to an appearance frequency for each of specific values or categories associated with the nodes in the first graph information and the attribute value of the coupling including the nodes with which the specific values or categories are associated.

6. The non-transitory computer-readable recording medium according to claim 5,
wherein the coefficient is a relative ratio corresponding to the appearance frequency with respect to a reference value.

7. The non-transitory computer-readable recording medium according to claim 6,
wherein the reference value is an average value or a median of the appearance frequencies.

8. The non-transitory computer-readable recording medium according to claim 5,
wherein the coefficient is a value within a specific range centered at 1.

9. A machine learning apparatus comprising:
a memory, and
a processor coupled to the memory and configured to:
acquire first graph information;
generate second graph information, without changing a coupling state between nodes included in the first graph information, by a change process of changing an attribute value of a coupling between the nodes; and
perform machine learning on a model, based on the first graph information and the second graph information.

10. The machine learning apparatus according to claim 9,
wherein the without changing the coupling state comprises not adding any new coupling between the nodes included in the first graph information and not deleting any existing coupling between the nodes included in the first graph information.

11. The machine learning apparatus according to claim 9,
wherein the change process includes randomly changing the attribute value.

12. The machine learning apparatus according to claim 11,
wherein the randomly changing the attribute value includes randomly multiplying the attribute value by a value of a specific probability distribution.

13. The machine learning apparatus according to claim 9,
wherein the change process includes multiplying a coefficient corresponding to an appearance frequency for each of specific values or categories associated with the nodes in the first graph information and the attribute value of the coupling including the nodes with which the specific values or categories are associated.

14. The machine learning apparatus according to claim 13,
wherein the coefficient is a relative ratio corresponding to the appearance frequency with respect to a reference value.

15. The machine learning apparatus according to claim 14,
wherein the reference value is an average value or a median of the appearance frequencies.

16. The machine learning apparatus according to claim 13,
wherein the coefficient is a value within a specific range center at 1.

17. A machine learning method performed by a computer, the method comprising:
acquiring first graph information;
generating second graph information, without changing a coupling state between nodes included in the first graph information, by a change process of changing an attribute value of a coupling between the nodes; and
performing machine learning on a model, based on the first graph information and the second graph information.

18. The machine learning method according to claim 17,
wherein the without changing the coupling state comprises not adding any new coupling between the nodes included in the first graph information and not deleting any existing coupling between the nodes included in the first graph information.

19. The machine learning apparatus according to claim 18,
wherein the change process includes randomly changing the attribute value.

20. The machine learning method according to claim 19,
wherein the randomly changing the attribute value includes processing of randomly multiplying the attribute value by a value of a specific probability distribution.
